(19) United States
(12) Patent Application Publication
(10) Pub. No.: US 2026/0024541 A1
(43) Pub. Date: Jan. 22, 2026

(54) SPEECH ENHANCEMENT AND INTERFERENCE SUPPRESSION

(71) Applicant: Dolby Laboratories Licensing Corporation, San Francisco, CA (US)

(72) Inventor: Ning WANG, Epping (AU)

(73) Assignee: Dolby Laboratories Licensing Corporation, San Francisco, CA (US)

(21) Appl. No.: 18/874,542

(22) PCT Filed: Jun. 20, 2023
(86) PCT No.: PCT/US2023/025770

§ 371 Date: Dec. 12, 2024

Related U.S. Application Data
(60) Provisional application No. 63/355,328, filed on Jun. 24, 2022.
(60) Provisional application No. 63/489,347, filed on Mar. 9, 2023.

(51) Int. Cl. G10L 21/0264; G10L 21/0216

(52) U.S. Cl. CPC G10L 21/0264; G10L 2021/02166

(57) ABSTRACT

Methods, systems, and media for processing audio are provided. In some embodiments, a method involves receiving, from a plurality of microphones, an input audio signal. The method may involve identifying an angle of arrival associated with the input audio signal. The method may involve determining a plurality of gains corresponding to a plurality of bands of the input audio signal based on a combination of at least: 1) a representation of a covariance of signals associated with microphones of the plurality of microphones on a per-band basis; and 2) the angle of arrival. The method may involve applying the plurality of gains to the plurality of bands of the input audio signal such that at least a portion of the input audio signal is suppressed to form an enhanced audio signal.

### TECHNICAL FIELD

This application claims the benefit of priority from U.S. Provisional Patent Application No. 63/355,328, filed on Jun. 24, 2022 and U.S. Provisional Patent Application No. 63/489,347 filed on Mar. 9, 2023, each of which is incorporated by reference in its entirety.

This disclosure pertains to systems, methods, and media for speech enhancement and interference suppression.

### BACKGROUND

In various audio applications, such as with respect to audio conferencing technologies, it may difficult to hear a speaker of interest, particularly when the speaker of interest is competing with other noise and/or speakers. For example, with various audio conferencing technologies, in which multiple microphones may be used to pick up audio from multiple speakers within a room, it may be difficult to isolate and/or emphasize a speaker of interest relative to noise associated with other regions and/or microphones.

### NOTATION AND NOMENCLATURE

Throughout this disclosure, including in the claims, the terms “speaker,” “loudspeaker” and “audio reproduction transducer” are used synonymously to denote any sound-emitting transducer (or set of transducers). A typical set of headphones includes two speakers. A speaker may be implemented to include multiple transducers (e.g., a woofer and a tweeter), which may be driven by a single, common speaker feed or multiple speaker feeds. In some examples, the speaker feed(s) may undergo different processing in different circuitry branches coupled to the different transducers.

Throughout this disclosure, including in the claims, the expression performing an operation “on” a signal or data (e.g., filtering, scaling, transforming, or applying gain to, the signal or data) is used in a broad sense to denote performing the operation directly on the signal or data, or on a processed version of the signal or data (e.g., on a version of the signal that has undergone preliminary filtering or pre-processing prior to performance of the operation thereon).

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X-M inputs are received from an external source) may also be referred to as a decoder system.

Throughout this disclosure including in the claims, the term “processor” is used in a broad sense to denote a system or device programmable or otherwise configurable (e.g., with software or firmware) to perform operations on data (e.g., audio, or video or other image data). Examples of processors include a field-programmable gate array (or other configurable integrated circuit or chip set), a digital signal processor programmed and/or otherwise configured to perform pipelined processing on audio or other sound data, a programmable general purpose processor or computer, and a programmable microprocessor chip or chip set.

### SUMMARY

Methods, systems, and media for speech enhancement and interference suppression are provided. In some embodiments, a method may involve receiving, from a plurality of microphones, an input audio signal. The method may involve identifying an angle of arrival associated with the input audio signal. The method may involve determining a plurality of gains corresponding to a plurality of bands of the input audio signal based on a combination of at least: 1) a representation of a covariance of signals associated with microphones of the plurality of microphones on a per-band basis; and 2) the angle of arrival. The method may involve applying the plurality of gains to the plurality of bands of the input audio signal such that at least a portion of the input audio signal is suppressed to form an enhanced audio signal.

In some examples, identifying the angle of arrival comprises converting the signals received associated with microphones of the plurality of microphones to a spatial representation, and wherein the input audio signal corresponds to the spatial representation.

In some examples, determining the plurality of gains comprises: identifying one or more objects of the input audio signal; and clustering the one or more objects of the input audio signal as being within one of a plurality of clusters, wherein the plurality of gains associated with a current time frame of the input audio signal are determined based on a proximity of the current time frame of the input audio signal to objects within the clustering of the one or more objects. In some examples, identifying the one or more objects of the input audio signal is based on a current input and a historical input. In some examples, clustering the one or more objects of the input audio signal is responsive to determining the one or more audio objects have been present for more than a threshold number of frames of the input audio signal. In some examples, clustering a given object of the one or more objects of the input audio signal comprises one of: 1) updating an existing object in a cluster; 2) creating a new object in the cluster corresponding to the given object; or 3) replacing the existing object in the cluster with the given object. In some examples, the existing object that is replaced is the existing object with a lowest activity level of the cluster. In some examples, the clustering is on a broadband basis with respect to the plurality of bands. In some examples, clustering the one or more objects comprises determining a plurality of similarity metrics of the input audio signal to each cluster. In some examples, the plurality of similarity metrics correspond to the plurality of bands. In some examples, determining a similarity metric for a given cluster is based on a most active object within the given cluster. In some examples, the plurality of gains are determined using the plurality of similarity metrics. In some examples, the plurality of clusters comprise a within a region of interest cluster and an outside of the region of interest cluster. In some examples, a method further involves determining, for each band of the plurality of bands, a lower bound gain applicable to a portion of the input audio signal inside the region of interest and an upper bound gain applicable to a portion of the input audio outside e region of interest, wherein the plurality of gains are subject to the lower bound gain and the upper bound gain.

In some examples, applying the plurality of gains comprises: utilizing a linear filter to filter the input audio signal to generate a filtered signal; grouping the input audio signal and the filtered signal into the plurality of bands; calculating the plurality of gains for the plurality of bands by taking a difference between a power of the input audio signal and the filtered signal; determining a plurality of gain bounds; clamping the gains to the gain bounds; and applying the clamped gains to the input audio signal.

In some examples, applying the plurality of gains comprises: determining a ratio of spatial components of the input audio signal; and applying the plurality of gains based at least in part on the ratio of the spatial components.

In some examples, a method further involves smoothing the plurality of gains prior to applying the plurality of gains. In some examples, a method further involves causing the enhanced audio signal to be presented via a loudspeaker or headphones.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented via one or more non-transitory media having software stored thereon.

At least some aspects of the present disclosure may be implemented via an apparatus. For example, one or more devices may be capable of performing, at least in part, the methods disclosed herein. In some implementations, an apparatus is, or includes, an audio processing system having an interface system and a control system. The control system may include one or more general purpose single-or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating regions of interest in accordance with some embodiments.

FIG. 2 is a schematic block diagram of a system for enhancing speech within a region of interest and suppressing interference from outside the region of interest in accordance with some embodiments.

FIG. 3 is a flowchart of an example process for enhancing speech within a region of interest and suppressing interference from outside the region of interest in accordance with some embodiments.

FIG. 4 is a flowchart of an example process for clustering audio objects in accordance with some embodiments.

FIG. 5A is a flowchart of an example process for determining and utilizing similarity metrics for clustering audio objects in accordance with some embodiments.

FIG. 5B is a flowchart of an example process for determining similarity metrics for audio objects in accordance with some embodiments.

FIG. 5C is a flowchart of an example process for updating object ranks in accordance with some embodiments.

FIGS. 6A and 6B are schematic block diagrams for example beam forming systems in accordance with some embodiments.

FIG. 7 is a flowchart of an example process for enhancing speech in accordance with some embodiments.

FIG. 8 shows a block diagram that illustrates examples of components of an apparatus capable of implementing various aspects of this disclosure.

Like reference numbers and designations in the various drawings indicate like elements.

### DETAILED DESCRIPTION OF EMBODIMENTS

It may be difficult to accurately enhance audio signals of interest and suppress audio signals that are not of interest, e.g., interfering audio signals. For example, in an audio conferencing or video conferencing system, it may be desirable to enhance speech associated with a given speaker while suppressing speech of other speakers, noise, etc. Conventional noise suppression techniques may utilize beam forming techniques to suppress audio that is from outside a region of interest. However, conventional techniques may over-suppress audio that is of interest and under-suppress interfering audio that is not of interest, particularly in instances in which the audio to be suppressed includes competing talkers or other speech-like signals.

Disclosed herein are systems, methods, and media for speech enhancement. Using the techniques disclosed herein, gains may be determined and applied on a per-band basis. In some implementations, gains may be determined based on an angle of arrival of an input audio signal and based on a covariance between signals of different microphones on all bands of the system. The covariance is generally referred to herein as the power vector. In some implementations, audio objects in an input audio signal (generally referred to herein as “objects”) may be clustered based on the angle of arrival and the power vector. For example, objects may be clustered into a within a region of interest cluster or an outside the region of interest cluster. Gains may be determined on a per-band basis and utilizing the clustering. By determining gains using a clustering of audio objects, the techniques disclosed herein may avoid over suppressing signals associated with objects within a region of interest and avoid under suppressing signals associated with objects outside the region of interest. By determining and applying gains on a per-band basis, gains may be robustly applied even when the signals to suppress include competing speech (e.g., that competes with speech to be enhanced).

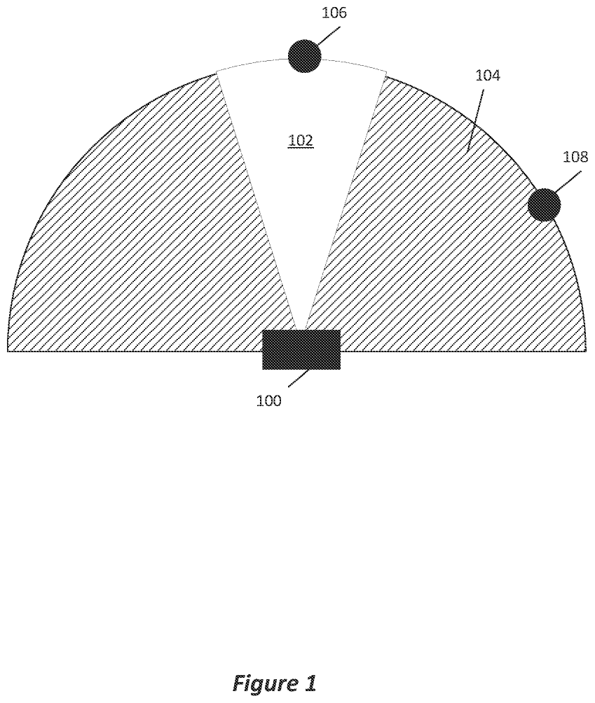

FIG. 1 is a diagram that illustrates a region of interest in accordance with some embodiments. A system 100 may include one or more microphones. For example, system 100 may be part of a video conferencing or audio conferencing system. System 100 may be associated with a region of interest 102. As illustrated, in some embodiments, region of interest 102 may be a sector that originates at system 100. The region surrounding region of interest 102 corresponds to outside region 104. System 100, using the techniques described herein, may enhance speech originating from a talker 106 who is within region of interest 102, while suppressing speech or noise originating from outside region 104, such as speech from talker 108.

In some implementations, the techniques described herein may apply beam forming techniques to signals from one or more microphones to suppress signals that are outside of a region of interest and to enhance signals that are within a region of interest. The beam forming techniques may be applied by determining gains on a per-band basis. Application of gains on a per-band basis, rather than on a broadband basis, may allow more accurate suppression of signals outside of a region of interest in a scenario with competing talkers (e.g., competing speech signals), as in an audio conferencing or video conferencing context. The gains may be determined using acoustic or audio scene analysis techniques. In particular, objects within an audio signal may be clustered as belonging to one of a plurality of clusters. In one example, the plurality of clusters may include a within a region of interest cluster and an outside the region of interest cluster. In another example, the plurality of clusters may include a within a region of interest cluster, an outside the region of interest cluster, and a transition zone cluster.

Gains may then be determined on a per-band basis for each cluster. In some embodiments, scene analysis may be performed by estimating an angle of arrival of an incoming audio signal. In some embodiments, scene analysis may be performed on a banded version of the incoming audio signal to enable gain determination on a per-band basis. In some implementations, gains may be determined based on a power vector, which may indicate the covariance of signals associated with different microphones on a per-band basis. Note that, because scene analysis and gain determination may be performed on a per-band basis, speech from competing talkers may be effectively enhanced or suppressed depending on the direction of interest, thereby allowing for more effective and robust noise suppression, even in the case of multiple talkers or competing speech signals.

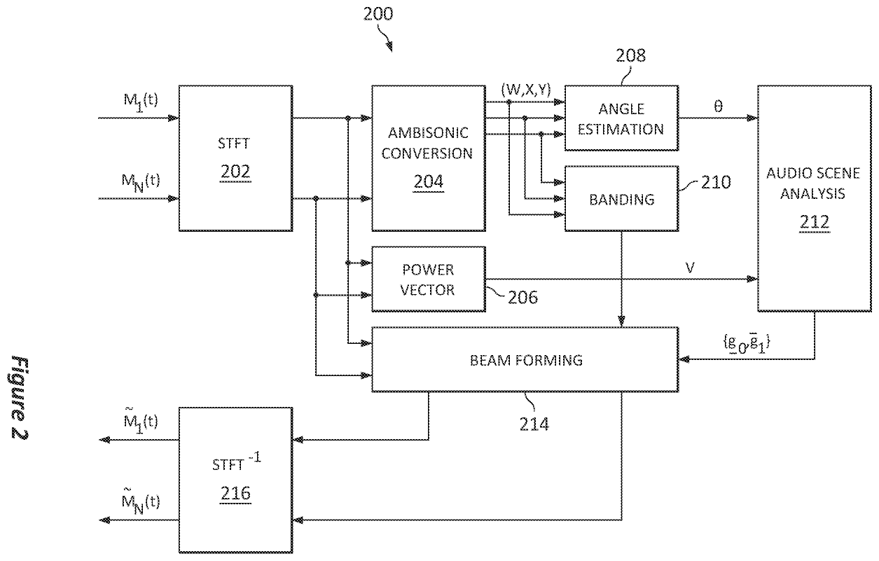

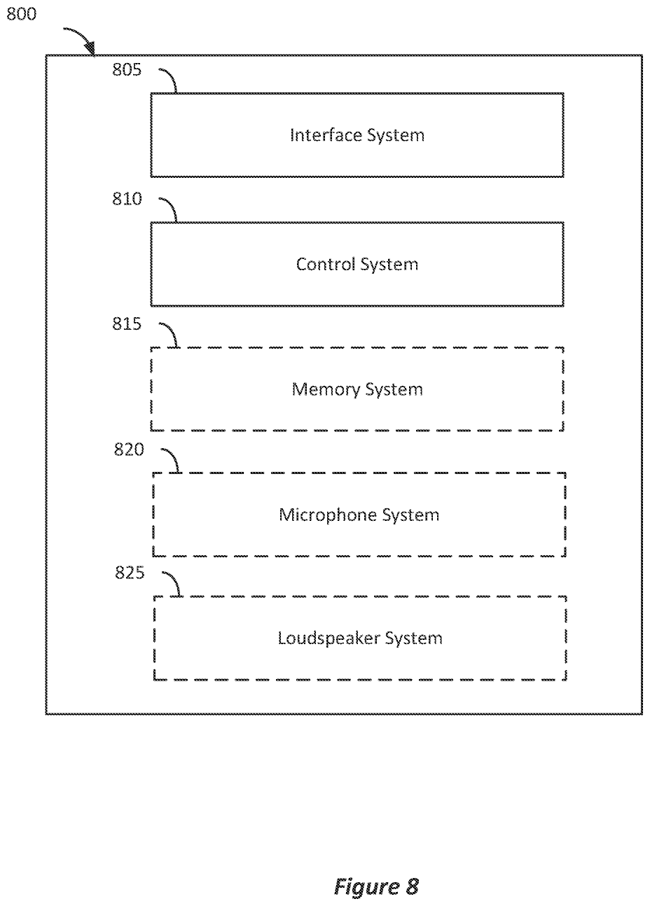

FIG. 2 is a schematic diagram of an example system 200 for applying beam forming techniques to an input audio signal in accordance with some implementations. Blocks of system 200 may be implemented on a user device, such as a laptop computer, a desktop computer, a computer or processor associated with an audio or video conferencing system, or the like. Example components of such a device are shown in and described below in connection with FIG. 8.

As illustrated, system 200 may acquire audio signals from a set of microphones (e.g., from one microphone, from two microphones, from five microphones, or the like). The set of input audio signals are generally referred to herein as M₁(t), M₂(t), . . . . M_{N}(t) for N microphones. The input audio signals from the microphones may be first processed by short-time Fourier transform (STFT) block 202. STFT block 202 may transform the input audio signals from a time domain to a frequency domain. For example, for a given frame n, the frequency domain representation generated by STFT block 202 may be represented as: M₁(n, k), M₂(n, k), . . . . M_{N}(n, k), where k=0, 1, . . . . K-1 and represents the discrete Fourier transform (DFT) bin index for K total bins. The frequency domain signals generated by STFT block 202 may then be passed to Ambisonic conversion block 204, power vector block 206, and beam forming block 214, as shown in FIG. 2.

Ambisonic conversion block 204 may convert the frequency domain audio signals to scene-based audio signals. In particular, Ambisonic conversion block 204 may transform the frequency domain audio signals to an Ambisonic format that includes, e.g., an X component corresponding to the front-back direction, a Y component corresponding to the left-right direction, and a W component corresponding to an omnidirectional component. Note that although a first-order Ambisonic format is generally used herein, other spatial encoding formats may be utilized. For a given frame n and a given DFT bin index k, Ambisonic conversion block 204 may generate an Ambisonic representation of the input audio signal represented by {W(n, k), X(n, k), Y(n, k)}.

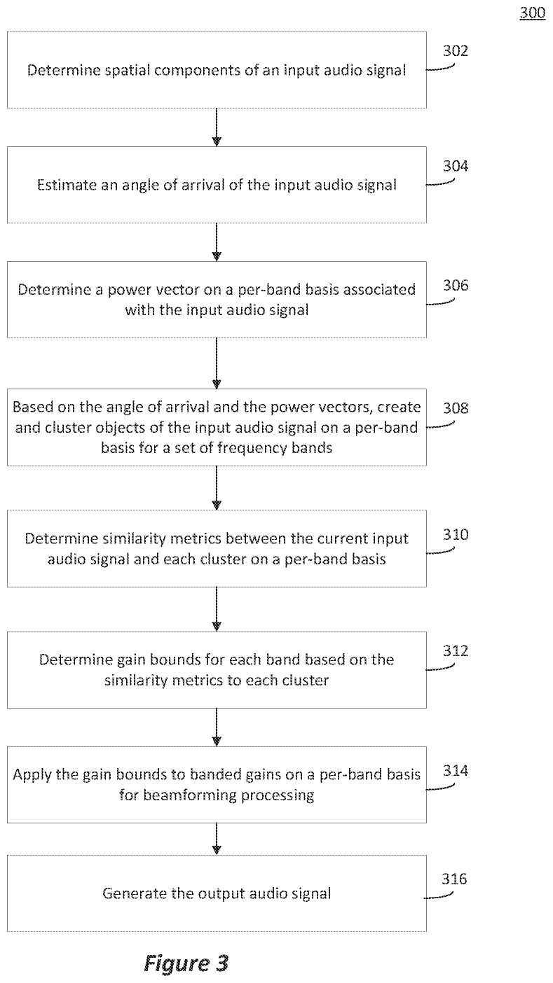

Power vector block 206 may be configured to determine a covariance between pairs of microphone signals on a per-band basis. For a given frame n, the power vector may be represented as v(n). More detailed techniques for determining the power vector are described below in connection with FIG. 3.

The Ambisonic representation of the audio signal for a given frame n may be passed to angle estimation block 208 and to banding block 210. Angle estimation block 208 may be configured to determine an angle of arrival of frame n of the input audio signal. The angle of arrival is generally represented herein as θ. More detailed techniques for determining the angle of arrival are described below in connection with FIG. 3.

Banding block 210 may be configured to separate the frequency domain representation of frame n of the input audio signal into a plurality of frequency bands. In some implementations, the banding may be in a domain of non-uniform bandwidth bands that, e.g., mimic frequency processing of the human cochlea. Results of banding block 210 may be utilized by beam forming block 214, as will be described below.

Audio scene analysis block 212 may receive the angle of arrival θ as well as the power vector v. Based on the angle of arrival θ and the power vector v, acoustic scene analysis block 212 may determine gain bounds on a per-band basis. The gain bounds may be determined with respect to a plurality of regions, e.g., an in-region area and an out-of-region area, as shown in and described above in connection with FIG. 1. More detailed techniques for determining the gain bounds for a set of regions are shown in and described below in connection with FIGS. 3-5. Note that, as used herein, a gain value is generally a negative value. Additionally, note that, the gain bounds may include, e.g., a lower gain bound applicable to audio objects within a region of interest, where the lower gain bound specifies a maximum gain to be applied to objects within the region of interest, thereby preventing over suppression of objects within the region of interest. The gain bounds may additionally or alternatively include an upper gain bound applicable to audio objects outside the region of interest, where the upper gain bound specifies a minimum gain to be applied to objects outside the region of interest, thereby preventing under suppression of objects outside the region of interest.

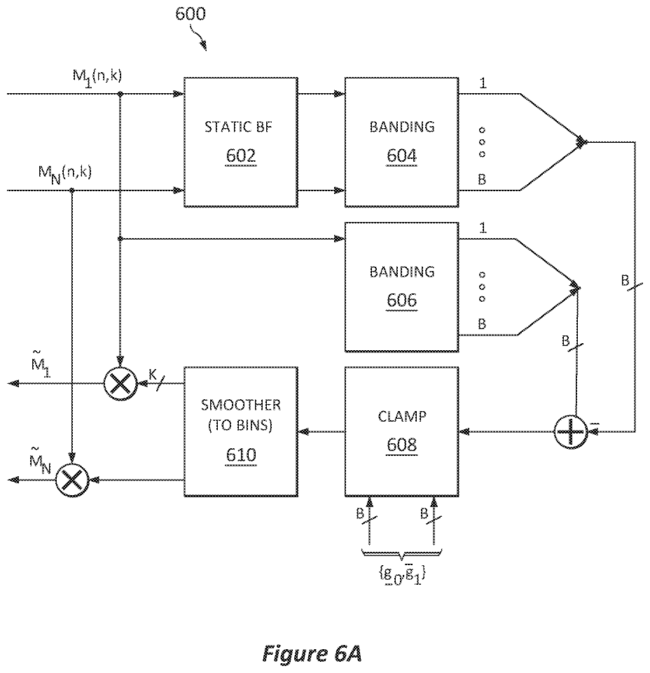

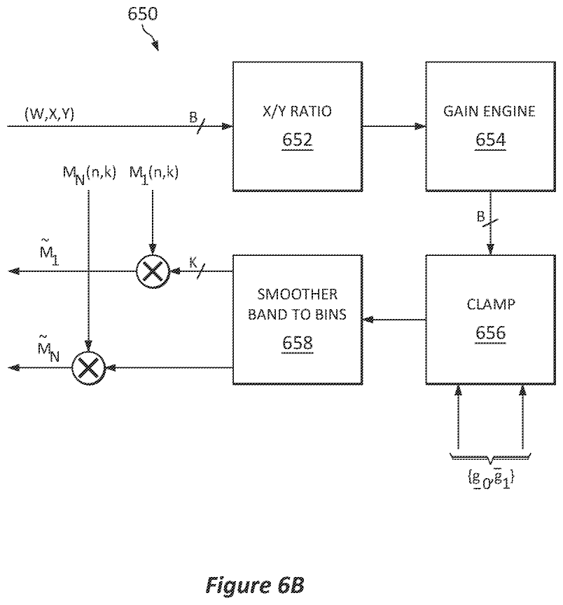

The gain bounds determined by audio scene analysis block 212 may be passed to beam forming block 214. Using the determined gain bounds as well as the banding information determined by banding block 210, beam forming block 214 may be configured to apply the gain bounds to a given frame n of the input audio signal. Note that gain bounds may be applied on a per-band basis rather than on a broadband basis. In some implementations, beam forming block 214 may perform smoothing on the gains prior to application of the gains. Example systems that may be implemented as beam forming block 214 are shown in and described below in connection with FIGS. 6A and 6B.

The modified audio signal (e.g., with the gains having been applied) may then be passed to inverse STFT block 216. Inverse STFT block 216 may transform the modified audio signal in the frequency domain to an enhanced audio signal in the time domain. The enhanced audio signal, for N microphones, may be represented herein as: m′₁(t), m′₂(t), . . . m′_{N}(t).

As described above, beam forming techniques may be applied to perform accurate and robust noise suppression and speech-of-interest enhancement, particularly in situations with multiple talkers or competing talkers. Gains may be determined on a per-band basis for each of a set of regions or clusters. For example, the clusters may correspond to a within a region of interest cluster and an outside the region of interest cluster, as shown in and described above in connection with FIG. 1. The gains may be determined based on gain bounds. The gain bounds may in turn be determined based on similarity metrics that indicate similarity of a current frame of an input audio signal and a set of clusters on a per-band basis. Note that audio objects may be created and clustered based on historical angle of arrival of the frames of the input audio signal and power vectors that represents the covariance between two signals from two microphones on a per-band basis. By applying the gains on a per-band basis, competing speech that is outside of the region of interest may be more effectively suppressed.

FIG. 3 is a flowchart of an example process 300 for speech enhancement in accordance with some implementations. Blocks of process 300 may be executed by a processor or a controller, such as a processor or a controller of a user device (e.g., a laptop computer, a desktop computer, a computer or processor associated with an audio or video conferencing system, or the like). Example components of such a device are shown in and described below in connection with FIG. 8. An example of a processor or controller that may be used is control system 810, shown in and described below in connection with FIG. 8. In some embodiments, blocks of process 300 may be executed in an order other than what is shown in FIG. 3. In some implementations, two or more blocks of process 300 may be executed substantially in parallel. In some implementations, one or more blocks of process 300 may be omitted.

Process 300 can begin at 302 by determining spatial components of an input audio signal. As described above in connection with FIG. 2, the input audio signal may be associated with a set of N microphones. The set of input audio signals may be represented as m₁(t), m₂(t), . . . m_{N}(t) for N microphones. Prior to determining the spatial components, the input audio signals may be transformed to a frequency domain, for example, using an STFT. The frequency domain signals may be represented as: M₁(n, k), M₂(n, k), . . . . M_{N}(n, k), where k=0, 1, . . . . K-1 and represents the discrete Fourier transform (DFT) bin index for K total bins. The spatial components of the input audio signal may then be determined (e.g., from the frequency domain representation) by performing an Ambisonic conversion. For example, for a given frame n, the Ambisonic representation may be given by: {W(n, k), X(n, k), Y(n, k)}, where W represents the omnidirectional component, X represents the front-back component, and Y represents the left-right component.

At 304, process 300 can estimate an angle of arrival of the input audio signal, generally represented herein as θ. For example, the angle of arrival may be estimated based on the spatial components. As a more particular example, given the Ambisonic representation that includes the W, X, and Y components, the angle of arrival may be estimated by based on the covariance matrix of the components. For example, the angle of arrival may be estimated by performing principal component analysis (PCA) on the covariance matrix. It should be understood that given W, X, and Y sound components, the sound field represented by these components may be represented by:

$$( \begin{matrix}W \\ X \\ Y\end{matrix} ) = {\sum }_{i} ( \begin{matrix}1 \\ cos {θ}_{i} \\ sin {θ}_{i}\end{matrix} ) Si$$

In the equation given above, S represents the sound source components, and i is an index that represents the component number. In the example given above, there will be at most three components which can be separated from (W, X, Y) and i may accordingly be iterated over 0, 1, and 2.

Accordingly, the covariance matrix for a given frame n may be presented as:

$$C o {v}_{0} ( n ) = α * Co {v}_{0} ( n - 1 ) + ( 1 - α ) \\ * 2 {\sum }_{k} Re \{ ( \begin{matrix}W ( n , k ) \\ X ( n , b k ) \\ Y ( n , k )\end{matrix} ) * ( W * ( n , k ) X * ( n , k ) Y * ( n , k ) ) \}$$

In the equation given above, a is a smoothing parameter, k represents the bin index, and W*, X*, and Y* represent the complex conjugates of W, X, and Y, respectively.

The covariance matrix Cov₀(n) may have an eigenvector with a largest eigenvalue of

$$( \begin{matrix}{f}_{0} \\ {f}_{1} \\ {f}_{2}\end{matrix} ) .$$

The angle of arrival may then be estimated based on the largest eigenvalue of the covariance matrix. In one example, the angle of arrival, θ, may be determined by:

$$θ = {tan}^{- 1} \frac{{f}_{1}}{{f}_{2}} .$$

At 306, process 300 can determine a power vector associated with the input audio signal. The power vector may indicate a covariance between signals associated with different microphones on a per-band basis. Given rectangular banding, in which each bin k contributes to exactly one output band with a gain of 1, a covariance for a band b and frame n, generally represented herein as Covₙ(b), may be determined by:

$${Cov}_{n} ( b ) = α * Co {v}_{n - 1} ( b ) + ( 1 - α ) * ( b )$$

In the equation given above, [symbol] (b)=Σ_{k=B(b)}M(n, k)*M^{H}(n, k). Note that B(b) represents the set of all STFT bins (e.g., subbands) that belong to band b, and a is a weighting factor configured to factor weighting contributions of past and estimated covariances. M^{H}(n, k) is a vector of length N, where N is the number of microphones and K is the number of bins.

In some implementations, M(n, k) may be represented as [M₁(n, k), M₂(n, k), . . . . M_{N}(n, k)]\hat{ }T.

Note that, for one bin k, weights w_{k,b} must sum to 1 over all bands b. Accordingly, the covariance for non-rectangular banding may be determined using weights w_{k,b} for different bands and bins. Note that cosine banding, triangular banding in linear, log, or Mel frequency may be utilized. The covariance Cₙ(b) may be determined using the equation given above for Covₙ(b) , but utilizing [symbol] (b)=Σ_{k=B(b)}w_{k,b}M(n, k)*M^{H}(n, K), where Σ_{k=B(b)}w_{k,b}=1.

As used herein, the power vector for a given band b is generally represented as v^{b}, where v^{b} is a normalized covariance matrix. In some implementations, a normalized covariance matrix may be a covariance matrix divided by its trace such that the normalized covariance matrix represents direction only with all level components removed. By way of example, for a system with three microphones, v^{b} may be determined by:

$${v}^{{}_{b}} = ( \begin{matrix}co {v}_{1 , 1} \\ co {v}_{2 , 2} \\ co {v}_{3 , 3} \\ Re \{ co {v}_{1 , 2} \} \\ Im \{ co {v}_{1 , 2} \} \\ Re \{ co {v}_{1 , 3} \} \\ Im \{ co {v}_{1 , 3} \} \\ Re \{ co {v}_{2 , 3} \} \\ Im \{ co {v}_{2 , 3} \}\end{matrix} )$$

In some implementations, the first element of each band may be 1.0, and may therefore be removed. The length of the power vector may be (N²−1)*B, where B is the total number of bands. The power vector v^{b} may be the power vector of band b with the first element removed, which may therefore have N²−1 real valued elements.

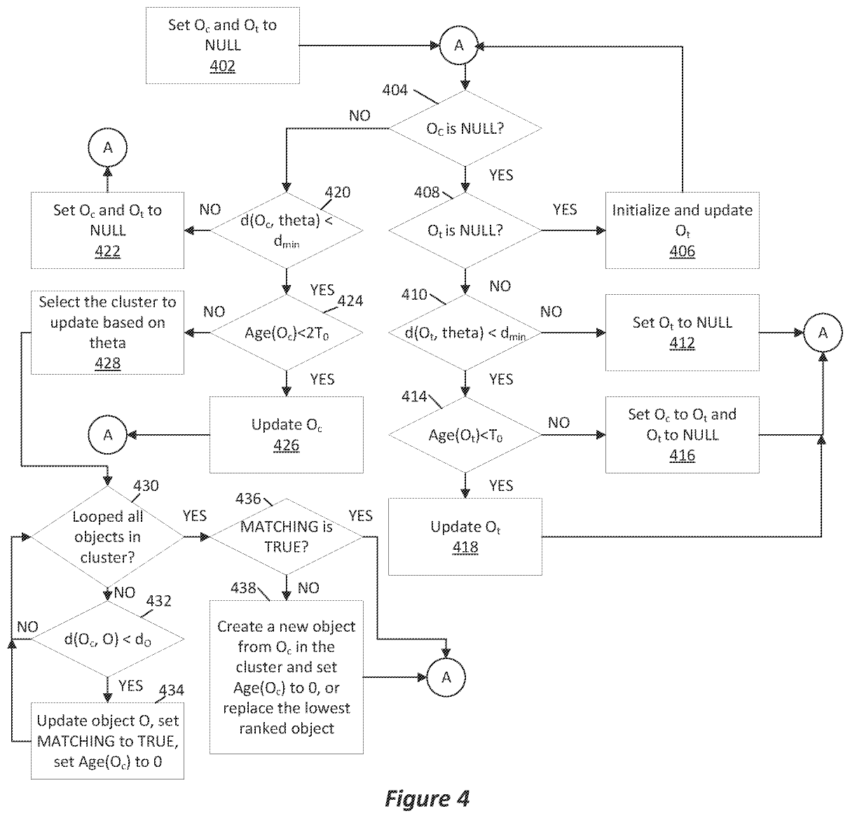

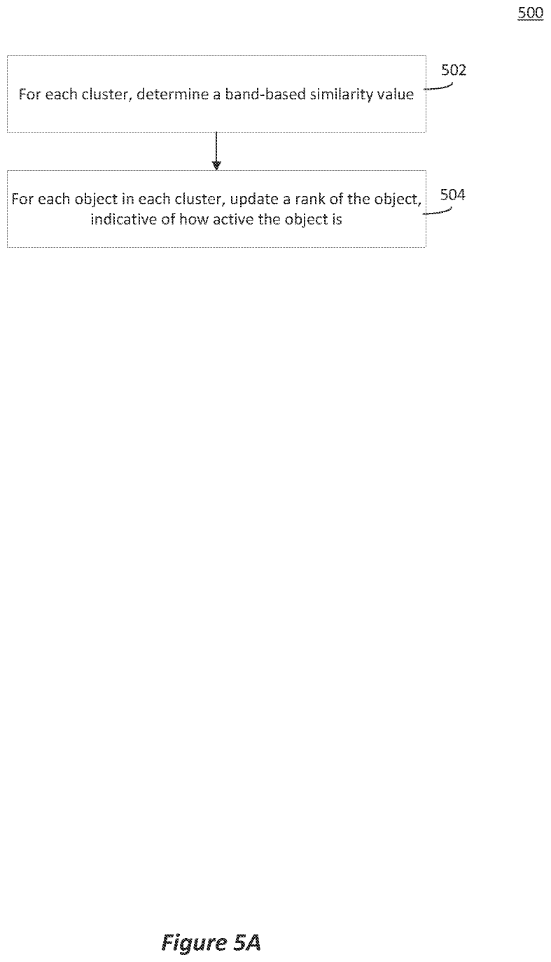

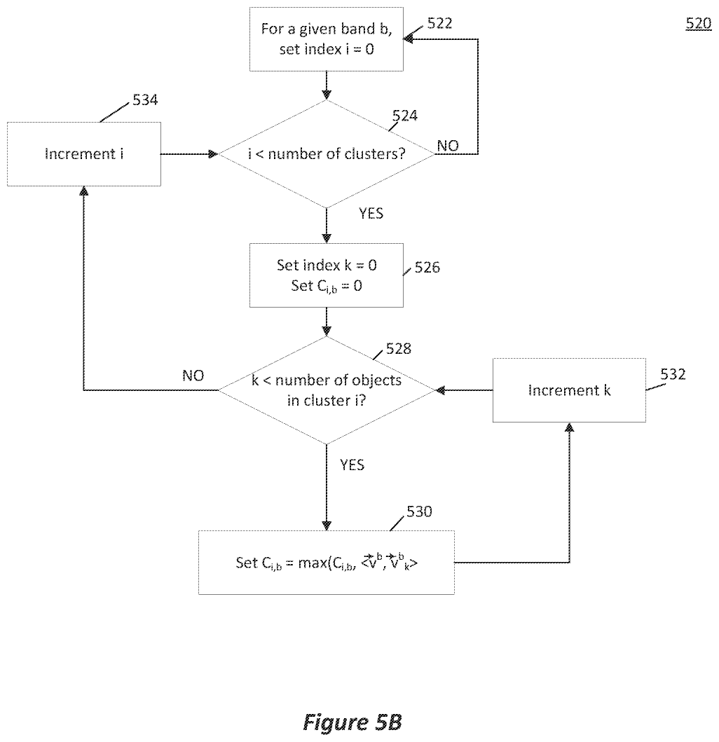

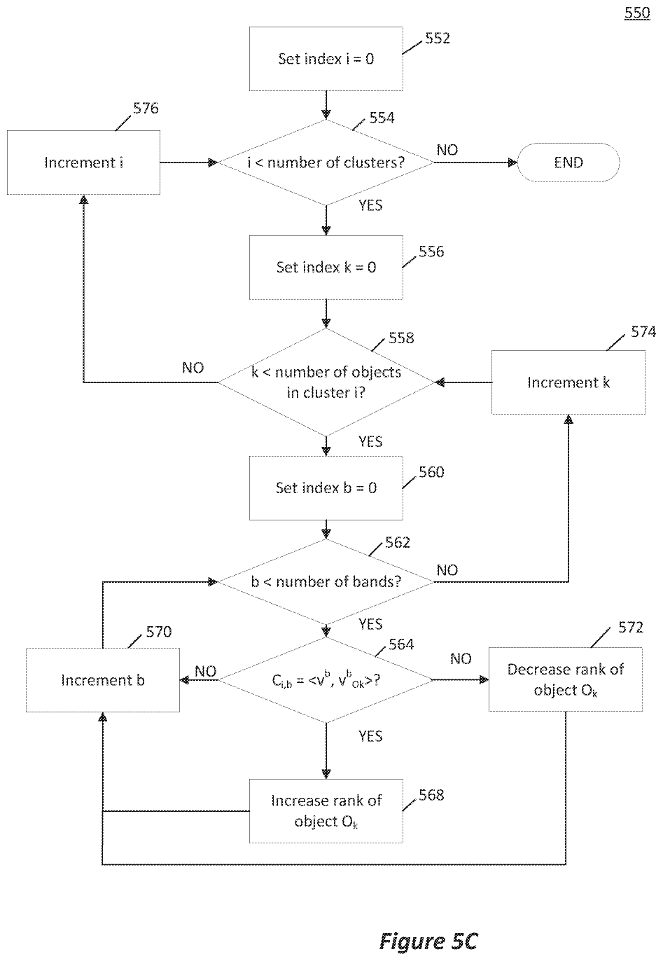

At 308, process 300 can create and cluster objects of the input audio signal on a per-band basis for a set of frequency bands based on the angle of arrival and the power vectors. In some embodiments, clustering may be performed based on the angle of arrival (e.g., as determined at block 304) and the power vector (e.g., as determined at block 306). In some embodiments, the set of clusters may include two clusters—a within a region of interest cluster and an outside the region of interest cluster. In some embodiments, the set of clusters may include three clusters, such as a within a region of interest cluster, an outside the region of interest cluster, and a transition zone cluster that corresponds to an area or region between the within region of interest cluster and the outside the region of interest cluster. Note that, although two clusters are generally described herein, the set of clusters may include any suitable number of clusters (e.g., two, three, five, ten, etc.). Additionally, it should be noted that, in some implementations, there may be a maximum number of objects permitted to be assigned to a given cluster. Accordingly, each cluster may include the M most salient or important objects within the cluster, where M represents the maximum permissible number of objects permitted in a given cluster Note that the M most salient or important objects may be determined, identified, or selected based on a rank of the object. An example technique for determining an object rank is shown in and described below in connection with FIG. 5B and 5C. Example values of objects that may be permitted in a given cluster include two, three, five, ten, or the like. FIG. 4 is a flowchart that depicts an example process for clustering objects of the input audio signal in accordance with some implementations.

At 310, process 300 can determine similarity metrics between the current input audio signal and each cluster on a per-band basis. For a given cluster i and a given frequency band b, the similarity metric may be represented as c_{i,b}. By way of example, given two clusters (e.g., a within region of interest cluster and an outside the region of interest cluster), for frequency band b, the similarity metrics may be represented as c_{in,b} and c_{out,b}. The similarity metric for a given cluster and a given band may be based on the power vectors of objects assigned to the cluster and for the given band. More detailed example techniques for determining similarity metrics are shown in and described below in connection with FIG. 5B.

At 312, process 300 can determine gain bounds for each band based on the similarity metrics to each cluster. Gain for a given band b may be represented herein as g_{b}. In some implementations, the gain for a given band may be determined based on upper and lower gain bounds determined for each cluster and each band. For example, in some implementations, a lower bound gain may be set for each band for the within the region of interest cluster, thereby ensuring that the gain is at least a predetermined level corresponding to the lower bound gain. Continuing with this example, an upper bound gain may be set for each band for the outside the region of interest cluster, thereby ensuring that the gain for each band is at least some minimum level corresponding to the upper bound gain. Note that, as used herein, the gain is a negative number. By way of example, given two clusters (e.g., a within region of interest cluster and an outside the region of interest cluster), the lower bound gain for band b for the within region cluster may be determined by:

$${g\_bound}_{in , b} = \{ \begin{matrix}0 dB if {c}_{in , b} > {β}_{0} * {c}_{out , b} \\ GL if {β}_{0} * {c}_{out , b} > {c}_{in , b} > {β}_{1} * {c}_{out , b} \\ - otherwise\end{matrix}$$

Continuing with this example, the upper bound for band b for the outside the region of interest cluster may be determined by:

$${g\_bound}_{out , b} = \{ \begin{matrix}{G}_{U} if {c}_{out , b} > {β}_{1} * {c}_{in , b} \\ 0 dB otherwise\end{matrix}$$

In the equations given above, β₀, β₁, and β₂ are constants. In some embodiments, G_{L} may have a value that is greater than G_{U}. In one example, G_{L} may be −10 dB and G_{U} may be −30 dB. In another example, G_{L} may be −20 dB and G_{U} may be −40 dB. In some implementations, the gain for a given band may be based on the upper and lower gain bounds (e.g., as described above) and a first pass beam forming gain for the band determined based on processing applied to the input audio signal by a beamforming system. Example beamforming systems and techniques for determining the gain for a given band based on the upper and lower gain bounds are shown in and described below in connection with FIGS. 6A and 6B.

It should be understood that clustering of objects (e.g., as described above in connection with block 308), determination of similarity metrics for each cluster and each band (e.g., as described above in connection with block 310), and determination of upper and lower gain bounds for each band (e.g., as described above in connection with block 312) may be implemented by a scene analysis block, e.g., as shown in and described above in connection with FIG. 2.

At 314, process 300 can apply the gain bounds to banded gains on a per-band basis. The gain bounds may be applied for beamforming processing. It should be noted that, in some implementations, prior to application of the gains, the gains may be smoothed (e.g., with respect to time, or frames of the audio signal) to prevent discontinuous jumps in the applied gains. Process 300 may generate a modified audio signal in the frequency domain by applying the gains on a per-band basis.

At 316, process 300 may generate the output audio signal, sometimes referred to herein as an enhanced audio signal. For example, process 300 may transform the modified audio signal (e.g., generated at block 314) to the time domain to generate the output audio signal. As a more particular example, in some implementations, process 300 may apply an inverse STFT to the modified audio signal to generate the output audio signal. Note that, the output audio signal may be one in which at least a portion of the input audio signal has been suppressed. The suppressed portion may correspond to speech or noise that is outside of a region of interest. Accordingly, the output audio signal may be considered an enhanced audio signal.

As described above in connection with FIGS. 2 and 3, objects of an input audio signal may be clustered as belonging to one of a set of clusters. In some implementations, a historical context of an object of the input audio signal may be considered when performing clustering. For example, in some implementations, an object may only be assigned to a cluster if the object has been present in more than a predetermined number of frames of the input audio signal or for more than a predetermined duration of time within the input audio signal. In some implementations, the historical context of the object may be considered by utilizing a temporary object (generally represented herein as Oₜ) which tracks an object of the input audio signal that has not yet been present in the input audio signal for a minimum duration of time or minimum number of frames, and a current object (generally represented herein as O_{c}), which tracks an object of the input audio signal that has been present in the input audio signal for more than the minimum duration of time or the minimum number of frames, but has not yet been assigned to a cluster.

FIG. 4 is a flowchart of an example process 400 for clustering an object O of an input audio signal in accordance with some implementations. Note that object O is associated with a feature space formed by the angle of arrival associated with the object and the power vector associated with the object. The feature space may be represented by

$$( \begin{matrix}\overline{θ} \\ \overline{v}\end{matrix} ) .$$

In some implementations, blocks of process 400 may be executed by a processor or a controller, such as a processor or a controller of a user device (e.g., a laptop computer, a desktop computer, a computer or processor associated with an audio or video conferencing system, or the like). An example of such a processor or controller is control system 810, shown in and described below in connection with FIG. 8. In some embodiments, blocks of process 400 may be executed in an order other than what is shown in FIG. 4. In some implementations, two or more blocks of process 400 may be executed substantially in parallel. In some implementations, one or more blocks of process 400 may be omitted.

Process 400 can begin at 402 by setting Oₜ and O_{c} the temporary and current objects, respectively to null, or an empty state. Process 400 can then proceed to point A. As illustrated in FIG. 4, process 400 may loop back to point A after various operations.

At 404, process 400 can determine whether O_{c} is null. In other words, process 400 can determine if, during a previous iteration of process 400, a previous version of the temporary object Oₜ had been present for sufficient frames in the input audio signal to be assigned to be a current object O_{c}. If, at 404, process 400 determines that O_{c} is null (i.e., O_{c} was not previously assigned in a previous iteration of process 400), or “yes” at 404, process 400 can proceed to block 408 and can determine whether Oₜ is current null or empty. In other words, process 400 can determine whether a temporary object, which has not yet been assigned to a current object (O_{c}) to be assigned to a cluster, has been initialized. If, at 404, process 400 determines that Oₜ is null (“yes” at 404), process 400 can proceed to 406 and can initialize and update Oₜ. For example, to initialize and update Oₜ, process 400 can set Oₜ to have the feature space of an object in the current frame of the input audio signal having angle of arrival θ and power vector

Conversely, if, at 408, process 400 determines that Oₜ is not null, process 400 can proceed to block 410 and can determine whether a distance between Oₜ and the angle of arrival associated with an object in the input audio signal frame (represented as θ) is less than a minimum distance threshold, represented as dmin. In some implementations, the distance may be determined as:

$$d ( {O}_{t} , θ ) = {\vert cos \overline{{θ}_{Ot}} - cos θ \vert}^{2} + {\vert sin \overline{{θ}_{Ot}} - sin θ \vert}^{2}$$

If, at 410, process 400 determines that the distance between Oₜ and the angle of arrival of the object in the input audio signal frame is not less than the minimum distance threshold (“no” at 410), process 400 can proceed to block 412 and can reset Oₜ to null. In other words, process 400 can determine that the current object does not correspond to the previously stored version of Oₜ responsive to determining the distance between Oₜ and the angle of arrival exceeds the minimum distance threshold. Conversely, if, at 410, process 400 determines that the distance between Oₜ and the angle of arrival of the object in the input audio signal frame is less than the minimum distance threshold (“yes” at 410), process 400 can proceed to block 414 and can determine whether the age of Oₜ is less than the first time threshold, generally represented herein as T₀. In other words, process 400 can determine whether the object of the frame of the input audio signal (corresponding to Oₜ) has been present for a duration of time corresponding to the first time threshold T₀. If, at 414, process 400 determines that the age of Oₜ is less than the first time threshold T₀ (“yes” at 414), process 400 can proceed to block 418 and can update Oₜ. For example, updating Oₜ may involve updating Oₜ to combine the current angle of arrival θ and power vector v associated with the current frame of the input audio signal and θ and v associated with Oₜ. In one example, an object O may be updated by:

$$\overline{{θ}_{O}} ( n ) = \overline{{θ}_{O}} ( n ) \cdot {α}_{θ} + θ \cdot ( 1 - {α}_{θ} ) \\ \overline{{v}_{O}} ( n ) = \overline{{v}_{O}} ( n ) \cdot {α}_{v} + v \cdot ( 1 - {α}_{v} )$$

Conversely, if, at 414, process 400 determines that the age of Oₜ exceeds the first time threshold T₀ (“no” at 414), process 400 can proceed to block 416 and can set O_{c} to Oₜ and set Oₜ to null, or empty. In other words, once process 400 has determined that the temporary object Oₜ has been present in the input audio signal for more than the first time threshold, process 400 can promote the temporary object to be the current object which is to be clustered and reset the temporary object to null, or empty, in order to track a new temporary object. Process 400 can then proceed back to point A.

Referring back to block 404, if, at 404, process 400 determines that O_{c} is not null, or empty (“no” at 404), process 400 can proceed to block 420 and can determine whether a distance between O_{c} and the angle of arrival of an object of the current frame of the input audio signal is less than the minimum distance threshold dₘᵢₙ. For example, the distance may be determined by:

$$d ( {O}_{c} , θ ) = {\vert cos \overline{{θ}_{Oc}} - cos θ \vert}^{2} + {\vert sin \overline{{θ}_{Oc}} - sin θ \vert}^{2}$$

If, at 420, process 400 determines that the distance between O_{c} and the angle of arrival of the object of the current frame is not less than the minimum distance threshold (“no” at 420), process 400 can proceed to block 422 and can set both O_{c} and Oₜ to null, or empty. Process 400 can then return back to point A such that another temporary object may be tracked and, optionally, eventually promoted to a current object. Conversely, if, at 420, process 400 determines that the distance between O_{c} and the angle of arrival of the object of the current frame is less than the minimum distance threshold (“yes” at 420), process 400 can proceed to block 424 and can determine whether the age of the current object O_{c} is less than a second time threshold. In some implementations, the second time threshold may be twice the first time threshold. For example, in FIG. 4, the second time threshold is represented as 2*T₀. Alternatively, in some implementations, the second time threshold may be a time duration that is larger than the first time threshold, such as 1.2*T₀, 1.5*T₀, 3*T₀, etc.

If, at 424, process 400 determines that the age of O_{c} is less than the second time threshold (“yes” at 424), process 400 can proceed to block 426 and can update O_{c}. For example, process 400 can update O_{c} based on the angle of arrival θ and the power vector v associated with the current frame of the input audio signal. Conversely, if, at 424, process 400 determines that the age of O_{c} meets or exceeds the second time threshold (“no” at 424), process 400 can proceed to block 428 and can select a cluster to update based on the angle of arrival associated with the current frame of the audio signal, generally represented herein as θ. For example, given a within region of interest cluster and an out of region cluster, process 400 may select one of the two clusters based on the angle of arrival, e.g., the cluster that is closest to the angle of arrival.

After selecting a cluster, process 400 can, at 430, determine whether all objects in the cluster have already been looped through. If, at 430, process 400 determines that not all objects have been looped through in a given cluster (“no” at 430), process 400 can proceed to block 432 and can determine whether the distance between a given object O within the cluster that is being looped through and object O_{c} is less than a minimum matching distance, generally represented herein as d₎. In other words, if the distance between the given object O and object O_{c} is less than the minimum matching distance, process 400 may determine that the object O_{c} is sufficiently similar to the object O so as to essentially be the same with respect to location and/or angle of arrival. The distance may be determined by:

$$d ( {O}_{c} , O ) = {\vert cos \overline{{θ}_{Oc}} - cos \overline{{θ}_{O}} \vert}^{2} + {\vert sin \overline{{θ}_{Oc}} - sin \overline{{θ}_{O}} \vert}^{2}$$

If, at 432, process 400 determines that the distance between O_{c} and the given object O in the cluster that is being looped over is less than the minimum matching distance (“yes” at 432), process 400 can proceed to block 434 and can update the object O. In particular, process 400 can update object O to have the feature space of object O_{c}. Process 400 may additionally set a “matching” status variable to TRUE, thereby indicating that a match for object O_{c} has been found, and may re-set the age of object O_{c} to 0.

Conversely, if, at 434, the distance between O_{c} and the given object O exceeds the minimum matching threshold, process 400 may loop back to block 430 and select the next object from the cluster that is being looped over. Once all objects in the cluster have been looped over (e.g., “yes” at 430), process 400 may proceed to block 436 and determine whether the “matching” status variable has been set to TRUE (e.g., at block 434). In other words, process 400 may determine whether a match has been identified for current object O_{c} within a given cluster. If a match has been found (“yes” at block 436), process 400 may return to point A.

Conversely, if no match has been found (“no” at block 436), process 400 may proceed to block 438 and may either create a new object based on object O_{c} or may replace the lowest ranking object in the cluster with O_{c}. Process 400 may then set the age of O_{c} to 0. Note that the rank of the object may represent the importance of the object with respect to how much speech the object is associated with. In other words, the rank may indicate a speech-activity level associated with the object. Note that, at block 438, process 400 may determine whether to create a new object based on object O_{c} or whether to replace the lowest ranking object in the cluster based on whether the cluster already has a maximum number of permissible objects in the cluster. After execution of block 438, process 400 may return to point A.

As described above in connection with FIG. 3, in some implementations, gains may be determined based on a similarity metric. Moreover, objects may be maintained in a cluster or removed from a cluster based on a rank of the object, where the rank indicates activity level with respect to speech activity of the object. In some implementations, the rank may be determined based on a similarity metric of a given band for a given cluster. For example, within a given cluster, the object with the highest rank may be the object that is most active relative to the current object O_{c} . For a given band, an object in the cluster may be considered the most active when it is closest (e.g., having the smallest similarity metric) to O_{c} for that band. In some implementations, the most active object in a given cluster is the object that has the most number of bands that are active.

FIG. 5A is a flowchart of an example process 500 for determining similarity metrics and updating object ranks in accordance with some embodiments. In some implementations, blocks of process 500 may be executed by a processor or a controller, such as a processor or a controller of a user device (e.g., a laptop computer, a desktop computer, a controller or processor associated with an audio or video conferencing system, or the like). An example of such a controller or processor is control system 810, shown in and described below in connection with FIG. 8. In some embodiments, blocks of process 500 may be executed in an order other than what is shown in FIG. 5A. In some implementations, two or more blocks of process 500 may be executed substantially in parallel. In some implementations, one or more blocks of process 500 may be omitted.

Process 500 may begin at 502 by determining, for each cluster in the set of clusters, and for each frequency band, a similarity metric. As described above, in some implementations, the set of clusters may include a within a region of interest cluster and an outside the region of interest cluster. In other implementations, the set of clusters may include three, four, five, ten, etc. clusters. For a given band b, the similarity metric for a cluster i may be set as the maximum vector inner product of the power vector for the cluster i and for the band b and the power vector of an object within cluster i that maximizes the inner product. By way of example, the similarity metric for a band b and for a cluster i may be determined by:

$${c}_{i , b} ← max ( {c}_{i , b} , 〈 {v}^{{}_{b}} , {v}_{O}^{b} 〉 )$$

To utilize the equation given above, for a given cluster i, process 500 may loop through the objects assigned to the cluster i and either maintain the previous value of the similarity metric, or update the value of the similarity metric based on the inner product value for the object in the current loop iteration. An example process for looping over objects to determine the similarity metric is shown in and described below in connection with FIG. 5B.

At 504, process 500 may update the rank of each object in each cluster. As described above, the rank may be indicative of how active the object is with respect to speech activity. The rank of a given object may reflect the degree to which the object contributes to the similarity metric assigned to the cluster for a given band b. For example, in an instance in which the similarity metric for a given cluster i and band b is equal to the inner product of the power vector for the band b and the power vector for band b of the object, the rank of the object may be increased (e.g., by one, by two, etc.). Conversely, in an instance in which the similarity metric for a given cluster i and for band b is not equal to the inner product of the power vector for the band b and the power vector for band b of the object, the rank of the object may be decreased (e.g., by five, by ten, by twenty, etc.). In this way, the object that contributes the most to the similarity metric of a given cluster may have the highest rank value. Recall that, as described above in connection with FIG. 4, in instances in which clusters are permitted a maximum number of objects, objects with the lowest rank may be replaced. Accordingly, objects that contribute the least to a similarity metric of the cluster may be replaced, whereas objects that contribute more to the similarity metric may be kept in the cluster.

FIG. 5B illustrates a flowchart of an example process 520 for determining similarity values on a per-band basis for clusters of a set of clusters in accordance with some embodiments. In some implementations, blocks of process 520 may be executed by a processor or a controller, such as a processor or a controller of a user device (e.g., a laptop computer, a desktop computer, a computer or processor associated with an audio or video conferencing system, or the like). In some embodiments, blocks of process 520 may be executed in an order other than what is shown in FIG. 5B. In some implementations, two or more blocks of process 520 may be executed substantially in parallel. In some implementations, one or more blocks of process 520 may be omitted. It should be noted that, in some implementations, process 520 may begin at 522 as a result of determining that the age of a current object (generally represented as O_{c}) is greater than a minimum age. For example, process 520 may correspond to block 428 of FIG. 4. In other words, in some implementations, process 520 may begin responsive to determining the age of the current object O_{c} exceeds the minimum age (e.g., “no” at block 424 of FIG. 4).

Process 520 may begin at block 522 by setting an index i, used to loop over the set of clusters for a given band b. Note that process 520 may be iterated over multiple frequency bands in the set of frequency bands. At 524, process 500 may determine whether i is less than the total number of clusters (i.e., to determine whether all clusters have been looped over). If, at 524, process 500 determines that i is less than the total number of clusters (“yes” at 524), process 520 can proceed to block 526 and can set index k to 0, where k is an index for looping over the objects in cluster i. At 526, process 520 can initialize the similarity metric for band b and cluster i to 0. That is, process 520 can set Cib to 0. At 528, process 520 can determine whether k is less than a number of objects in cluster i (i.e., to determine whether all objects in cluster i have been looped over). If, at 528, process 520 determines that k is less than the number of objects in cluster i (“yes” at 528), process 520 can proceed to 530 and can set similarity metric c_{i,b} to the maximum of: 1) the current value of c_{i,b}; and 2) the vector inner product of the power vector for band b (represented as v^{b}) and the power vector for the current object k for band b (represented as v^{b}ₖ) . Process 520 can then increment k at 532. Process 520 can loop over the objects until k meets or exceeds the number of objects in cluster i (“no” at 528). Responsive to determining that all objects in cluster i have been looped over, process 520 can increment i at block 534 to advance to the next cluster. Process 520 can loop through all clusters until determining that index i meets or exceeds the number of clusters (“no” at 524). Once all clusters have been looped over (“no” at 524), process 520 can loop back to block 522 and loop through another band b.

FIG. 5C is a flowchart of an example process 550 for updating the ranks of objects in accordance with some embodiments. In some implementations, blocks of process 550 may be executed by a processor or a controller, such as a processor or a controller of a user device (e.g., a laptop computer, a desktop computer, a computer or processor associated with an audio or video conferencing system, or the like). In some embodiments, blocks of process 550 may be executed in an order other than what is shown in FIG. 5C. In some implementations, two or more blocks of process 550 may be executed substantially in parallel. In some implementations, one or more blocks of process 550 may be omitted.

Process 550 may begin at 552 by setting an index i, used to loop over the set of clusters, to 0. At 554, process 550 may determine whether all clusters have been looped over by determining whether i is less than the number of clusters. If i is less than the number of clusters (“yes” at 554), process 550 can proceed to block 556 and can set index k, used to loop over the objects in cluster i, to 0. At 558, process 550 can determine whether all objects in cluster i have been looped over by determining whether k is less than the number of objects in cluster i. If, at 558, process 550 determines that not all objects have been looped over (“yes” at 558), process 550 can proceed to block 560 and can set index b, used to loop over all bands, to 0. At 562, process 550 can determine whether all bands of the set of frequency bands have been looped over by determining whether b is less than the number of bands. If, at 562, process 550 determines that not all bands have been looped over (“yes” at 562), process 550 can proceed to block 564. At 564, process 550 can determine whether the similarity metric for cluster i and band b, represented by c_{i,b}, is equal to the inner product of the power vector of band b and the power vector of object k in cluster i at band b. If the similarity metric for cluster i and band b is equal to the inner product of the power vector of band b and the power vector of object k in cluster i at band b (“yes” at 564), process 550 can increase the rank of object k in cluster i at block 568. For example, the rank may be increased by one, two, three, five, etc. Conversely, if the similarity metric for cluster i and band h is not equal to the inner product of the power vector of band b and the power vector of object k in cluster i at band b (“no” at 564), process 550 may decrease the rank of object k at block 572. For example, the rank may be decreased by five, ten, twenty, or the like. Process 550 can then increment index b at 570 and proceed to the next band. Process 550 can then loop through all bands until it is determined that all bands have been looped over (“no” at block 562). After looping through all bands, process 550 can increment the object index k at 574 to continue looping through the objects of cluster i. Once it is determined that all objects in cluster i have been looped over (“no” at block 558), process 550 may increment index i at 576 to loop over the next cluster. Once it is determined that all clusters have been looped over (“no” at block 554), process 550 can end.

As described above in connection with FIG. 2, in some implementations, gains may be applied by a beam forming block. The beam forming block may take, as inputs, the input audio signal (which may be in the frequency domain), banding information, and upper and/or lower gain bounds (e.g., as determined by an audio scene analysis block and as described above in connection with FIG. 3). In some implementations, the beam forming block may employ a linear filter. In other implementations, the beam forming block may determine a ratio of spatial components, such as a ratio of the X component of an input audio signal to a Y component of the input audio signal, and apply gains based on the ratio of the spatial components.

FIG. 6A is a schematic diagram of a beam forming block 600 that utilizes a linear filter. Beam forming block 600 may be used in system 200 as shown in and described above in connection with FIG. 2. For example, beam forming block 600 may correspond to beam forming block 214 of FIG. 2. As illustrated in FIG. 6A, beam forming block 600 may include a static beam forming block 602. Static beam forming block 602 may be configured to apply a linear filter to the input audio signal to generate a filtered audio signal. The input audio signal and the filtered audio signal may be grouped into a plurality of bands via, e.g., banding blocks 604 and/or 606. Note that any suitable number of banding blocks may be utilized, although only two are illustrated in FIG. 6A. A plurality of gains may be determined by taking a difference between a power of the input audio signal and the filtered signal. Gain bounds (e.g., as determined by a scene analysis block) for each cluster may be provided to clamping block 608. Given two clusters corresponding to a within a region of interest cluster and an outside the region of interest cluster, the gain bounds may be represented by g₀ and g₁, where g₀ represents the lower bounds for a within a region of interest cluster and where g₁ represents the upper bound for an outside the region of interest cluster. The gains determined by the difference in power may be clamped using the gain bounds by clamping block 608 such that the clamped gains adhere to the gain bounds. The clamped gains for each band are represented as g_{b}, and may be smoothed (e.g., over time, or over frames of the audio signal) by smoothing block 610. The smoothed gains may then be applied on a per-band basis to the audio signal to generate a modified audio signal. The modified audio signal may be in the frequency domain, and may be converted to the time domain to generate an enhanced audio signal.

FIG. 6B illustrates an example of beam forming block 650 that utilizes a ratio of spatial components of the input audio signal to determine gains in accordance with some implementations. As illustrated, X/Y ratio block 652 may take, as inputs, the W, X, and Y spatial components of the input audio signal. The spatial components may be obtained from an Ambisonic conversion block, e.g., as shown in FIG. 2. Gain engine 654 may then determine an first pass beam forming gain value, generally represented herein as g_{b}^{p}, based on the spatial components. For example, in some implementations, the first pass beam forming gain value may be determined by:

$${g}_{b}^{p} = \{ \begin{matrix}{G}_{heavy} if {L}_{x} ( n , b ) < {L}_{y} ( n , b ) \\ {G}_{mid} if {L}_{y} ( n , b ) \leq {L}_{x} ( n , b ) < 1.5 * {L}_{y} ( n , b ) \\ \begin{matrix}{G}_{light} else if {L}_{x} ( n , b - 1 ) < 1.2 * {L}_{y} ( n , b - 1 ) or \\ {L}_{x} ( n , b + 1 ) < 1.2 * {L}_{y} ( n , b + 1 )\end{matrix}\end{matrix}$$

Example values of G_{heavy}, G_{mid}, and G_{light} include {−40 dB, −20 dB, −10 dB}, {-50 dB, −30 dB, −20 dB}, {−50 dB, −30 dB, −10 dB}, etc.

Clamping block 656 may take as input gu, as well as gain bounds for each cluster. By way of example, given two clusters corresponding to a within a region of interest cluster and an outside the region of interest cluster, the gain bounds may be represented by g₀ and g₁, where go represents the lower bounds for a within a region of interest cluster and where g₁ represents the upper bound for an outside the region of interest cluster. Clamping block 656 may generate a gain for each band (represented as g_{b}) by clamping the first pass beam forming gain g_{b}^{p} subject to the gain bounds. In one example, the gain for a given band b may be determined by:

$${g}_{b} = min ( max ( {g}_{b}^{p} , {g}_{0 , b} ) , {g}_{1 , b} )$$

In the equation given above, g_{0,b} represents the lower gain bound for a within region of interest cluster, and g_{1,b} represents an upper gain bound for an outside the region of interest cluster.

Similar to what is described above in connection with FIG. 6A, the gains may be smoothed by smoothing block 658. The smoothed gains may then be applied to the input audio signal on a per-band basis to generate a modified audio signal. The modified audio signal may then be transformed to the time domain to generate an enhanced audio signal.

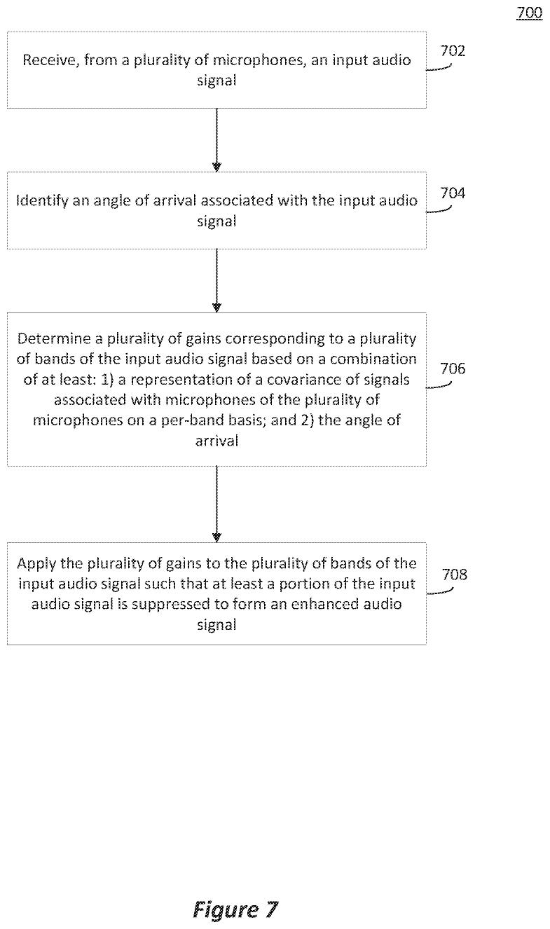

FIG. 7 is a flowchart of an example process for generating an enhanced audio signal in accordance with some implementations. In some implementations, blocks of process 700 may be executed by a processor or a controller, such as a processor or a controller of a user device (e.g., a laptop computer, a desktop computer, a controller or processor associated with an audio or video conferencing system, or the like). An example of such a controller or processor is control system 810, shown in and described below in connection with FIG. 8. In some embodiments, blocks of process 700 may be executed in an order other than what is shown in FIG. 7. In some implementations, two or more blocks of process 700 may be executed substantially in parallel. In some implementations, one or more blocks of process 700 may be omitted.

Process 700 may begin at 702 by receiving, from a plurality of microphones, an input audio signal. The number of microphones may be two, three, five, etc. The microphones may be associated with an audio conferencing or video conferencing system. In some implementations, a representation of the input audio signal may be transformed from the time domain to the frequency domain.

At 704, process 700 may identify an angle of arrival associated with the input audio signal. The angle of arrival may be identified with respect to a particular frame of the input audio signal. In some implementations, the angle of arrival may be identified based on an Ambisonic representation (e.g., a first order Ambisonic representation) of the input audio signal, or based on any other suitable spatial component representation of the input audio signal. An example technique for determining the angle of arrival is described above in connection with FIG. 3.

At 706, process 700 may determine a plurality of gains corresponding to a plurality of bands of the input audio signal based on a combination of at least: 1) a representation of a covariance associated with microphones of the plurality of microphones on a per-band basis; and 2) the angle of arrival. The representation of the covariance associated with microphones may be a power vector. Example techniques for determining the power vector are described above in connection with FIG. 3. Note that gains are determined on a per-band basis. In some implementations, the gains may be determined subject to one or more gain bounds, as shown in and described above in connection with FIG. 3. For example, a first gain bound may be applicable to a region of interest, while a second gain bound may be application to outside the region of interest, thereby ensuring that audio objects are not over suppressed when within the region of interest, and audio objects outside the region of interest are sufficiently suppressed.

At 708, process 700 may apply the plurality of gains to the plurality of bands of the input audio signal such that at least a portion of the input audio signal is suppressed to form an enhanced audio signal. Note that the gains are applied on a per-band basis, thereby allowing more robust suppression of competing speech that is, e.g., outside a region of interest. In some implementations, gains may be smoothed prior to application, as shown in and described above in connection with FIGS. 6A and 6B. Note that, after application of the gains to form a modified audio signal, the enhanced audio signal may be generated by transforming the modified audio signal from the frequency domain to the time domain (e.g., using an inverse STFT, as shown in and described above in connection with FIG. 2).

In some implementations, the enhanced audio signal may be presented (e.g., via a pair of loudspeakers, via a pair of headphones, etc.). In some implementations, the enhanced audio signal may be stored, e.g., in memory of a device, for later playback.

FIG. 8 is a block diagram that shows examples of components of an apparatus capable of implementing various aspects of this disclosure. As with other figures provided herein, the types and numbers of elements shown in FIG. 8 are merely provided by way of example. Oₜ her implementations may include more, fewer and/or different types and numbers of elements. According to some examples, the apparatus 800 may be configured for performing at least some of the methods disclosed herein. In some implementations, the apparatus 800 may be, or may include, a television, one or more components of an audio system, a mobile device (such as a cellular telephone), a laptop computer, a tablet device, a smart speaker, or another type of device.

According to some alternative implementations the apparatus 800 may be, or may include, a server. In some such examples, the apparatus 800 may be, or may include, an encoder. Accordingly, in some instances the apparatus 800 may be a device that is configured for use within an audio environment, such as a home audio environment, whereas in other instances the apparatus 700 may be a device that is configured for use in “the cloud,” e.g., a server.

In this example, the apparatus 800 includes an interface system 805 and a control system 810. The interface system 805 may, in some implementations, be configured for communication with one or more other devices of an audio environment. The audio environment may, in some examples, be a home audio environment. In other examples, the audio environment may be another type of environment, such as an office environment, an automobile environment, a train environment, a street or sidewalk environment, a park environment, etc. The interface system 805 may, in some implementations, be configured for exchanging control information and associated data with audio devices of the audio environment. The control information and associated data may, in some examples, pertain to one or more software applications that the apparatus 800 is executing.

The interface system 805 may, in some implementations, be configured for receiving, or for providing, a content stream. The content stream may include audio data. The audio data may include, but may not be limited to, audio signals. In some instances, the audio data may include spatial data, such as channel data and/or spatial metadata. In some examples, the content stream may include video data and audio data corresponding to the video data.

The interface system 805 may include one or more network interfaces and/or one or more external device interfaces (such as one or more universal serial bus (USB) interfaces).

According to some implementations, the interface system 805 may include one or more wireless interfaces. The interface system 805 may include one or more devices for implementing a user interface, such as one or more microphones, one or more speakers, a display system, a touch sensor system and/or a gesture sensor system. In some examples, the interface system 805 may include one or more interfaces between the control system 810 and a memory system, such as the optional memory system 815 shown in FIG. 8. However, the control system 810 may include a memory system in some instances. The interface system 805 may, in some implementations, be configured for receiving input from one or more microphones in an environment.

The control system 810 may, for example, include a general purpose single-or multi-chip processor, a digital signal processor (DSP), an application specific integrated circuit (ASIC), a field programmable gate array (FPGA) or other programmable logic device, discrete gate or transistor logic, and/or discrete hardware components.

In some implementations, the control system 810 may reside in more than one device. For example, in some implementations a portion of the control system 810 may reside in a device within one of the environments depicted herein and another portion of the control system 810 may reside in a device that is outside the environment, such as a server, a mobile device (e.g., a smartphone or a tablet computer), etc. In other examples, a portion of the control system 810 may reside in a device within one environment and another portion of the control system 810 may reside in one or more other devices of the environment. For example, a portion of the control system 810 may reside in a device that is implementing a cloud-based service, such as a server, and another portion of the control system 810 may reside in another device that is implementing the cloud-based service, such as another server, a memory device, etc. The interface system 805 also may, in some examples, reside in more than one device.

In some implementations, the control system 810 may be configured for performing, at least in part, the methods disclosed herein. According to some examples, the control system 810 may be configured for implementing methods of enhancing speech of interest and/or suppressing interfering noise, or the like.

Some or all of the methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. The one or more non-transitory media may, for example, reside in the optional memory system 815 shown in FIG. 8 and/or in the control system 810. Accordingly, various innovative aspects of the subject matter described in this disclosure can be implemented in one or more non-transitory media having software stored thereon. The software may, for example, perform scene analysis, determine gain bounds for different clusters, determine gains for different frequency bands, apply gains to an audio signal to generate a modified or an enhanced audio signal, etc. The software may, for example, be executable by one or more components of a control system such as the control system 810 of FIG. 8.

In some examples, the apparatus 800 may include the optional microphone system 820 shown in FIG. 8. The optional microphone system 820 may include one or more microphones. In some implementations, one or more of the microphones may be part of, or associated with, another device, such as a speaker of the speaker system, a smart audio device, etc. In some examples, the apparatus 800 may not include a microphone system 820. However, in some such implementations the apparatus 800 may nonetheless be configured to receive microphone data for one or more microphones in an audio environment via the interface system 810. In some such implementations, a cloud-based implementation of the apparatus 800 may be configured to receive microphone data, or a noise metric corresponding at least in part to the microphone data, from one or more microphones in an audio environment via the interface system 810.

According to some implementations, the apparatus 800 may include the optional loudspeaker system 825 shown in FIG. 8. The optional loudspeaker system 825 may include one or more loudspeakers, which also may be referred to herein as “speakers” or, more generally, as “audio reproduction transducers.” In some examples (e.g., cloud-based implementations), the apparatus 800 may not include a loudspeaker system 825. In some implementations, the apparatus 800 may include headphones. Headphones may be connected or coupled to the apparatus 800 via a headphone jack or via a wireless connection (e.g., BLUETOOTH).

Some aspects of present disclosure include a system or device configured (e.g., programmed) to perform one or more examples of the disclosed methods, and a tangible computer readable medium (e.g., a disc) which stores code for implementing one or more examples of the disclosed methods or steps thereof. For example, some disclosed systems can be or include a programmable general purpose processor, digital signal processor, or microprocessor, programmed with software or firmware and/or otherwise configured to perform any of a variety of operations on data, including an embodiment of disclosed methods or steps thereof. Such a general purpose processor may be or include a computer system including an input device, a memory, and a processing subsystem that is programmed (and/or otherwise configured) to perform one or more examples of the disclosed methods (or steps thereof) in response to data asserted thereto.

Some embodiments may be implemented as a configurable (e.g., programmable) digital signal processor (DSP) that is configured (e.g., programmed and otherwise configured) to perform required processing on audio signal(s), including performance of one or more examples of the disclosed methods. Alternatively, embodiments of the disclosed systems (or elements thereof) may be implemented as a general purpose processor (e.g., a personal computer (PC) or other computer system or microprocessor, which may include an input device and a memory) which is programmed with software or firmware and/or otherwise configured to perform any of a variety of operations including one or more examples of the disclosed methods. Alternatively, elements of some embodiments of the inventive system are implemented as a general purpose processor or DSP configured (e.g., programmed) to perform one or more examples of the disclosed methods, and the system also includes other elements (e.g., one or more loudspeakers and/or one or more microphones). A general purpose processor configured to perform one or more examples of the disclosed methods may be coupled to an input device (e.g., a mouse and/or a keyboard), a memory, and a display device.

Another aspect of present disclosure is a computer readable medium (for example, a disc or other tangible storage medium) which stores code for performing (e.g., coder executable to perform) one or more examples of the disclosed methods or steps thereof.

While specific embodiments of the present disclosure and applications of the disclosure have been described herein, it will be apparent to those of ordinary skill in the art that many variations on the embodiments and applications described herein are possible without departing from the scope of the disclosure described and claimed herein. It should be understood that while certain forms of the disclosure have been shown and described, the disclosure is not to be limited to the specific embodiments described and shown or the specific methods described.

1. A method of processing audio, the method comprising:
receiving, from a plurality of microphones, an input audio signal;
identifying an angle of arrival associated with the input audio signal;
determining a plurality of gains corresponding to a plurality of bands of the input audio signal based on a combination of at least: 1) a representation of a covariance of signals associated with microphones of the plurality of microphones on a per-band basis; and 2) the angle of arrival; and
applying the plurality of gains to the plurality of bands of the input audio signal such that at least a portion of the input audio signal is suppressed to form an enhanced audio signal.

2. The method of claim 1, wherein identifying the angle of arrival comprises converting the signals received associated with microphones of the plurality of microphones to a spatial representation, and wherein the input audio signal corresponds to the spatial representation.

3. The method of claim 1, wherein determining the plurality of gains comprises:
identifying one or more objects of the input audio signal; and
clustering the one or more objects of the input audio signal as being within one of a plurality of clusters, wherein the plurality of gains associated with a current time frame of the input audio signal are determined based on a proximity of the current time frame of the input audio signal to objects within the clustering of the one or more objects.

4. The method of claim 3, wherein identifying the one or more objects of the input audio signal is based on a current input and a historical input.

5. The method of claim 3, wherein clustering the one or more objects of the input audio signal is responsive to determining the one or more audio objects have been present for more than a threshold number of frames of the input audio signal.

6. The method of claim 3, wherein clustering a given object of the one or more objects of the input audio signal comprises one of: 1) updating an existing object in a cluster; 2) creating a new object in the cluster corresponding to the given object; or 3) replacing the existing object in the cluster with the given object.

7. The method of claim 6, wherein the existing object that is replaced is the existing object with a lowest activity level of the cluster.

8. The method of claim 3, wherein the clustering is on a broadband basis with respect to the plurality of bands.

9. The method of claim 3, wherein clustering the one or more objects comprises determining a plurality of similarity metrics of the input audio signal to each cluster.

10. The method of claim 9, wherein the plurality of similarity metrics correspond to the plurality of bands.

11. The method of claim 9, wherein determining a similarity metric for a given cluster is based on a most active object within the given cluster.

12. The method of claim 9, wherein the plurality of gains are determined using the plurality of similarity metrics.

13. The method of claim 3, wherein the plurality of clusters comprise a within a region of interest cluster and an outside of the region of interest cluster.

14. The method of claim 13, further comprising determining, for each band of the plurality of bands, a lower bound gain applicable to a portion of the input audio signal inside the region of interest and an upper bound gain applicable to a portion of the input audio outside e region of interest, wherein the plurality of gains are subject to the lower bound gain and the upper bound gain.

15. The method of claim 1, wherein applying the plurality of gains comprises:
utilizing a linear filter to filter the input audio signal to generate a filtered signal;
grouping the input audio signal and the filtered signal into the plurality of bands;
calculating the plurality of gains for the plurality of bands by taking a difference between a power of the input audio signal and the filtered signal;
determining a plurality of gain bounds;
clamping the gains to the gain bounds; and
applying the clamped gains to the input audio signal.

16. The method of claim 1, wherein applying the plurality of gains comprises:
determining a ratio of spatial components of the input audio signal; and
applying the plurality of gains based at least in part on the ratio of the spatial components.

17. The method of claim 1, further comprising smoothing the plurality of gains prior to applying the plurality of gains.

18. The method of claim 17, further comprising causing the enhanced audio signal to be presented via a loudspeaker or headphones.

19. A system including one or more processors configured to perform operations of claim 1.

20. A computer program product configured to cause one or more processors to perform operations of claim 1.
